(19) United States
(12) Patent Application Publication
(10) Pub. No.: US 2008/0231035 A1
(43) Pub. Date: Sep. 25, 2008

(54) Belt Retractor

(76) Inventors: Stefan Breitschuh, Alling (DE); Daniel Ludicke, Dortmund (DE); Martin Schautt, Munchen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/064,790

(22) PCT Filed: Aug. 29, 2006
(86) PCT No.: PCT/EP2006/065757

§ 371 Date: Feb. 25, 2008

(30) Foreign Application Priority Data
Aug. 30, 2005 (DE) 10 2005 041 098.7

(51) Int. Cl. B65H 75/48; B60R 22/34

(52) U.S. Cl. 280/807; 242/384.7

(57) ABSTRACT

A belt retractor (10) is suitable especially for use in an adaptive seat belt system and has a rotatable belt roll (14), a rotary member (18) that can be connected in a torsion-proof manner to the belt roll (14), and an actuator (32; 72) which generates an actuating force and acts upon at least one frictional element (22, 22′) in order to engage said frictional element (22, 22′) with the rotary member (18) that can be connected in a torsion-proof manner to the belt roll (14) so as to decelerate a rotational movement of the belt roll (14). An arrangement for self-reinforcing the actuating force generated by the actuator (32, 72) is disposed between the actuator (32; 72) and the rotary member (18).

### CROSS-REFERENCE TO RELATED APPLICATION

This application is a U.S. national stage application of International Application No. PCT/EP2006/065757 filed Aug. 29, 2006, which designates the United States of America, and claims priority to German Application number 10 2005 041 098.7 filed Aug. 30, 2005, the contents of which are hereby incorporated by reference in their entirety.

### TECHNICAL FIELD

The invention relates to a belt retractor which is particularly suitable for use in an adaptive seat belt system.

### BACKGROUND

Conventional 3-(anchor-)point seat-belt systems for a front seat usually have a lower anchor point located underneath a seat in the B-pillar area of a motor vehicle. A belt strap is passed from this anchor point over the lap of a vehicle occupant to a seat-belt buckle affixed to the centre console. The belt strap is routed further over the chest of the occupant to a deflection point on the B-pillar at the height of the occupant's neck, where it is routed to an essentially parallel belt roll with a locking system on the inside of the B-pillar which can be configured in various ways.

Auxiliary precrash systems, such as seat-belt pretensioners, can pull the belt strap tight before a crash in order to increase the deceleration time and relative deceleration distance of the occupant. Seat-belt pretensioning systems are usually located on the seat-belt buckle or on the belt roll. The technical embodiments can be divided into two groups: reversible and irreversible systems. Irreversible systems can only be used once, whereby the most widely used type of irreversible systems are pyrotechnically activated. When the seat-belt pretensioner is triggered, the belt strap is pulled tight so that the vehicle occupant is pulled into an ideal sitting position and the belt strap then fits tightly across the body.

In the event of a crash, the locking system in current systems is activated by a mechanism, which may either be mechanical, for example a ratchet, centrifugal or inertia device, or electronic, by a control unit, for example in response to an appropriate signal from an acceleration sensor.

To prevent injuries caused by the seat-belt system, a belt load limiter is usually also provided, which limits the load exerted on the vehicle occupant by the belt strap, for example by means of a torsion bar which deforms at a predefined belt load. Once the locking system has been triggered, the flow of forces in the seat-belt system is routed through the torsion bar, which, as mentioned above, deforms at a predefined belt load, thus limiting the load exerted on the vehicle occupant by the belt strap.

Accordingly, in most of the seat-belt systems common nowadays, a belt load level is determined at which deformation of the torsion bar and therefore belt load limiting is possible. Some systems enable a single mechanical switch between two different belt load levels. However, in all systems, it is necessary to determine the belt load level or levels at which the torsion bar is to deform, for example by means of an appropriate design of the torsion bar, during the design of the system. Average and/or empirical values regarding the size and weight of a vehicle occupant, the sitting position and the driving and crash situation, etc. are usually used for this.

Consequently, it is possible that, if a very small, light vehicle occupant is involved in a crash situation for instance, the belt load level for sufficient deformation of the torsion bar will never be reached. This can result in an increased risk of injury. By contrast, for very large, heavy vehicle occupants, the belt load limiter may cause the deceleration effect of the seat-belt system to be insufficient, so that there is the possibility that these persons may be propelled too far into the airbag.

Furthermore, these systems are not able to react to changes to other parameters, such as a vehicle occupant being “out of position” or specific driving or crash situations, which may be characterized by a certain driving speed, a particular crash impulse or the relevant environmental situation.

### SUMMARY

There is therefore a need for an adaptive seat-belt system in which the load exerted on the vehicle occupant by the belt strap, and the movement of the vehicle occupant in the event of a crash can be individually controlled as a function of specific occupant-, vehicle- and situation-specific parameters at the time of the crash.

A compactly configured belt retractor that is suitable for use in an adaptive seat-belt system of this type can be obtained according to an embodiment by a belt retractor comprising a rotatable belt roll, a rotary member that can be connected to the belt roll in a torsion-proof manner, and an actuator that generates an actuating force and acts upon at least one frictional element in order to engage the frictional element with the rotary member that can be connected to the belt roll in a torsion-proof manner so as to decelerate a rotational movement of the belt roll, wherein an arrangement for self-reinforcing the actuating force generated by the actuator is disposed between the actuator and the rotary member.

According to a further embodiment, the actuator can be connected to an electronic control unit that is configured to control the actuator as a function of at least one occupant-, vehicle- and/or situation-specific parameter in order to effect a deceleration of the rotational movement of the belt roll that is adapted thereto. According to a further embodiment, the self-reinforcing arrangement may comprise a first carrier part that carries at least one first force-amplification element and a second carrier part that carries at least one second force-amplification element, wherein the first and the second carrier parts can be rotated relative to each other as a result of the actuating force generated by the actuator. According to a further embodiment, the first force-amplification element may comprise an angled wedge face with an angle of inclination that is supported on the second force-amplification element in a sliding or rolling manner. According to a further embodiment, the first force-amplification element and the second force-amplification element may form a ball/ramp arrangement. According to a further embodiment, the first force-amplification element may be configured as a thread provided on the first carrier part and the second force-amplification element may be configured as a spindle that interacts with the thread provided on the first carrier part. According to a further embodiment, the second carrier part can be fixed and the first carrier part can be connected to the actuator in order to turn the first carrier part relative to the second carrier part. According to a further embodiment, the actuator can be configured as a rotating electric machine and can be connected to toothed or worm gearing. According to a further embodiment, the actuator can be configured as a direct drive or as a piezoelectric drive. According to a further embodiment, the actuator can be positioned radially outside the belt roll and essentially adjacent to the belt roll. According to a further embodiment, the actuator can be positioned radially outside the rotary member and essentially adjacent to the rotary member. According to a further embodiment, the actuator can be positioned on a side of the rotary member that faces away from the belt roll and essentially adjacent to the rotary member. According to a further embodiment, the first carrier part can be mounted in such a way that it can be moved along its axis of rotation and carries at least a first frictional element on a surface that faces the rotary member. According to a further embodiment, the rotary member can be mounted in such a way that it can be moved along its axis of rotation. According to a further embodiment, at least one second frictional element can be attached to a surface of the second carrier part that faces the rotary member. According to a further embodiment, a return spring can be provided to set a distance between the first and the second carrier part. According to a further embodiment, at least one spacer element can be provided to set a neutral position of the rotary member relative to the first and second carrier parts. According to a further embodiment, the self-reinforcing arrangement may comprise a spring element that is configured to apply a force that acts on the first carrier part in a circumferential direction of the first carrier part. According to a further embodiment, the at least one friction lining can be made from a magnetic material and/or a pot-type magnet can be provided that applies a magnetic force to the rotary member and/or the first carrier part in order to force the rotary member towards the at least one friction lining. According to a further embodiment, The method can be used in an adaptive seat-belt system.

### BRIEF DESCRIPTION OF THE DRAWINGS

Various embodiments of the belt retractor according to the invention are now explained in more detail with reference to the attached schematic drawings, in which:

FIG. 1 shows, in longitudinal cross-section, a section of a first embodiment of the belt retractor,

FIG. 2 shows a top view of a wedge arrangement used in the first embodiment of the belt retractor as shown in FIG. 1,

FIG. 3 shows the equilibrium of forces in a first wedge of the wedge arrangement as shown in FIG. 2,

FIG. 4 shows, in longitudinal cross-section, a section of a second embodiment of the belt retractor equipped with a support for the wedge arrangement,

FIG. 5 shows, in longitudinal cross-section, a section of a third embodiment of the belt retractor equipped with a worm gear,

FIG. 6 shows a top view of the interesting components of the worm gear of the third embodiment of the belt roller as shown in FIG. 5

FIG. 7 shows, in longitudinal cross-section, a section of a fourth embodiment of the belt retractor equipped with an alternative wedge arrangement,

FIG. 8 shows, in a spatial illustration, a section of the fourth embodiment of the belt retractor as shown in FIG. 7,

FIG. 9 shows, in longitudinal cross-section, a section of a variant of the fourth embodiment of the belt retractor as shown in FIG. 7,

FIG. 10a-c shows various embodiments of an arrangement for setting a neutral position of a brake disc of the belt retractor relative to a first carrier part,

FIG. 11 shows, in longitudinal cross-section, a section of a fifth embodiment of the belt retractor,

FIG. 12 shows, in longitudinal cross-section, a section of sixth embodiment of the belt retractor equipped with a further alternative wedge arrangement,

FIG. 13 shows, in a spatial illustration, a section of the sixth embodiment of the belt retractor as shown in FIG. 12,

FIG. 14 shows, in longitudinal cross-section, a section of a seventh embodiment of the belt retractor,

FIG. 15 shows, in longitudinal cross-section, a section of an eighth embodiment of the belt retractor in which an actuator is positioned on a side of the brake disc facing away from the belt roll,

FIG. 16 shows, in longitudinal cross-section, a section of a ninth embodiment of the belt retractor equipped with a direct drive,

FIG. 17 shows, in longitudinal cross-section, a section of a tenth embodiment of the belt retractor also equipped with a direct drive,

FIG. 18 shows, in longitudinal cross-section, a section of an eleventh embodiment of the belt retractor equipped with a spindle arrangement,

FIG. 19 shows, in longitudinal cross-section, a section of a twelfth embodiment of the belt retractor equipped with a ball/ramp arrangement, and

FIG. 20 shows, in longitudinal cross-section, a section of a thirteenth embodiment of the belt retractor equipped with a coil spring.

### DETAILED DESCRIPTION

The belt retractor according to an embodiment exhibits a rotatable belt roll, a rotary member that can be connected in a torsion-proof manner to the belt roll, and an actuator. The rotary member can be permanently connected to a shaft of the belt roll in a torsion-proof manner for example, so that the rotary member always rotates with the belt roll about a common axis. Alternatively however, it is also possible to provide a suitable mechanism, for example a ratchet mechanism, which only connects the rotary member with the belt roll in a torsion-proof manner when required, that is if a deceleration of the rotational movement of the belt roll is desired. Finally, the rotary member can also be configured so that it is integrated in the belt roll, serving as a side wall of the belt roll for example. The actuator of the belt retractor according to an embodiment generates an actuating force and acts upon at least one frictional element in order to engage said frictional element with the rotary member that can be connected in a torsion-proof manner to the belt roll so as to decelerate a rotational movement of the belt roll. While the actuator exerts a deceleration force on the belt roll by means of the frictional element and the rotary member, the belt roll prevents a belt strap wrapped around said belt roll from unwinding. An arrangement for self-reinforcing the actuating force generated by the actuator is provided between the actuator and the rotary member. By means of this type of self-reinforcing arrangement, the actuating force that must be exerted by the actuator in order to achieve a desired deceleration effect can be significantly reduced. In this way, a compactly configured, lightweight actuator can be used. The belt retractor according to an embodiment thus has a sufficiently small volume to enable it to be accommodated in the usually very restricted installation space available in modern motor vehicles, for example in the B-pillar or C-pillar of the vehicle.

The actuator of the belt retractor according to an embodiment can preferably be connected to an electronic control unit that is configured to control and/or regulate the actuator as a function of occupant-, vehicle- and/or situation-specific parameters in order to bring about an appropriate deceleration of the rotational movement of the belt roll. The occupant-, vehicle- and/or situation-specific parameters can be determined by means of appropriate sensors, such as crash sensors, distance and contact sensors, radar sensors, environment recognition sensors, sitting-position and seat-position recognition sensors, acceleration sensors, centrifuge sensors, sensors for detecting the occupant's weight and/or the occupant's position, etc. Naturally, sensors that are already employed in a vehicle, for example for controlling the brake system, can be used for this. The sensors can be connected to the electronic control unit by means of a bus system for example. Because the actuator is controlled as a function of occupant-, vehicle- and/or situation-specific parameters, the rotational movement of the belt roll and thus the unwinding movement of the belt strap from the belt roll are also decelerated as a function of these parameters. This enables the force exerted on the vehicle occupant by the belt strap to be individually adapted to the occupant-, vehicle- and/or situation specific parameters determined by the sensors. A seat-belt system equipped with the belt retractor according to an embodiment thus guarantees improved passive safety in comparison to conventional systems.

In one embodiment of the belt retractor, the self-reinforcing arrangement comprises a first and second carrier part. The first carrier part carries at least a first force-amplification element and the second carrier part carries at least a second force-amplification element. The first and second carrier parts can preferably be turned relative to each other as a result of the actuating force generated by the actuator. In other words, the actuator interacts with the self-reinforcing arrangement in such a way that the actuating force that it generates causes the first and second carrier parts to turn relative to each other. Preferably, there may be a plurality of first and second force-amplification elements which are arranged to be rotationally symmetrical about the axis of rotation of the first and/or second carrier part. The first and/or second carrier part can be rotatable about the axis of rotation of the rotary member. If the rotary member, as described above, is connected to a shaft of the belt roll in a torsion-proof manner, the belt roll, the rotary member and the first and/or second carrier elements can thus preferably be arranged coaxially to each other.

The first force-amplification element can, for example, be configured in the form of a wedge-shaped component, comprising preferably an angled wedge face with a wedge angle of inclination a which is supported in a sliding or rolling manner on the second force-amplification element. The first force-amplification element is mounted on the first carrier part for example. However, the angled wedge face can also be configured directly on the first carrier part or on a component that is connected to the first carrier part, but which is not itself wedge-shaped. In order to support the angled wedge face of the first force-amplification element, the second force-amplification element can also comprise an angled wedge face opposite the wedge face of the first force-amplification element or a pin.

Alternatively, the first and second force-amplification elements can also form a ball/ramp arrangement. In a ball/ramp arrangement of this type, the angled wedge face of the first force-amplification element can preferably be formed by a sloped face with a wedge angle of inclination a which is provided on the first carrier part or a component connected to the first carrier part. The angled wedge face forms a track for guiding a ball or a roller, so that the angled wedge face is supported in a rolling manner on the ball or roller forming the second force-amplification element. The ball/ramp arrangement preferably may exhibit a plurality of angled wedge faces which are arranged on the first carrier part or the component connected to the first carrier part so as to be rotationally symmetrical about the axis of rotation of the first carrier part in order to form one or several ball rings. With a rotationally symmetrical arrangement of this type, either balls or conical rollers are used as the second force-amplification element, as appropriate.

If the first and second carrier parts are turned relative to each other as a result of the actuating force generated by the actuator, the angled wedge face of the first force-amplification element runs up against an angled wedge face of the second force-amplification element that is opposite the angled wedge face of the first force-amplification element for example. This will achieve a self-reinforcing effect dependent on the wedge angle of inclination a of the angled wedge face of the first force-amplification element.

In a further alternative embodiment of the belt retractor, the first force-amplification element is configured as a thread provided on the first carrier part. The second force-amplification element can preferably be a spindle which interacts with the thread provided on the first carrier part. The spindle can, for example, be configured such that it is a hollow cylinder and is penetrated by the shaft of the belt roll. If the first and second carrier parts are turned relative to each other, the interaction of the thread provided on the first carrier part with the spindle will achieve a self-reinforcing effect dependent on the spindle inclination.

The wedge angle of inclination α or the spindle inclination can be arranged in such a way that an input force introduced into the self-reinforcing arrangement by means of the actuator is always positive in relation to the direction of rotation of the rotary member, regardless of a changing friction coefficient between the at least one frictional element and the rotary member. In this context, this is known as a pressure arrangement, as the magnitude of the self-reinforcement caused by the selection of the wedge angle of inclination α or the spindle inclination is dimensioned to be only so great that, regardless of the changing frictional coefficient in all the operating states of the arrangement, a compressive force must be exerted on the angled wedge face or the spindle in order to achieve a desired frictional force. The compressive force is exerted by the actuator.

Alternatively, the wedge angle of inclination α or the spindle inclination can also be selected such that the input force introduced into the self-reinforcing arrangement by means of the actuator is always negative again in relation to the direction of rotation of the rotary member, regardless of the changing friction coefficient between the at least one frictional element and the rotary member. In contrast to the pressure arrangement described previously, where there is always a negative input force, one speaks of a pulling arrangement, that is, in every operating state of the arrangement, a pulling force must be exerted on the angled wedge face or the spindle in order to achieve the desired frictional force. A pulling arrangement of this type can be realized by the selection of a smaller wedge angle of inclination α in comparison to a pressure arrangement or a smaller spindle inclination in comparison to a pressure arrangement.

In a further embodiment of the belt retractor, the wedge angle of inclination α or the spindle inclination is selected such that the arrangement formed by the first and second force-amplification elements is positioned in an optimum operating state (usually that which occurs most often) close to a transition point between a pressure arrangement and a pulling arrangement. Close to the transition point, the input force to be applied by the actuator is near zero. A change in the friction coefficient, for example due to the temperature, brings about a pressure arrangement or a pulling arrangement.

The second carrier part is preferably fixed. By contrast, the first carrier part can preferably be connected to the actuator in order to turn the first carrier part relative to the second carrier part. In an arrangement of this type, the first force-amplification element thus moves relative to the second force-amplification element. The first carrier part can always be connected directly or indirectly by means of a gear mechanism with the first carrier part, regardless of the operating state of the belt retractor according to an embodiment. However, it is also conceivable to provide a suitable mechanism which only connects the actuator with the first carrier part directly or indirectly by means of a gear mechanism when required, e.g. in the event of a crash.

With regard to the configuration of the actuator, different variants are conceivable for the belt retractor according to various embodiments. According to a first embodiment, the actuator is configured as a rotating electric machine. An actuator of this type can be connected to a gear mechanism for example. Possible gear mechanisms are, for example, gear wheel gearing or alternatively, to achieve higher transmission ratios, worm gearing. The gear mechanism can transmit the rotational movement of a motor shaft, connected by means of a gear wheel or a worm for example, to the first carrier part for example, in order to turn the first carrier part relative to the second carrier part. The first carrier part can preferably be provided with toothing, for example external toothing, which interacts with a gear wheel connected to the actuator or a worm connected to the actuator.

In an alternative embodiment of the belt retractor, the actuator is configured as a direct drive. The term direct drive is used here to mean a drive that acts on the at least one frictional element by means of the self-reinforcing arrangement without interconnection by the gear mechanism. A direct drive of this type can be realized for example by means of a linear motor with a stator coil and a rotor comprising a magnetic material. The stator coil can preferably be arranged as a ring around an axis of rotation of the component to be turned, i.e. the first carrier part for example, and fixed to a section of the second carrier part that is essentially parallel to the rotary member. The rotor can be secured to the first carrier part for example, so that the first carrier part can be set in motion rotationally, i.e. turned relative to the second carrier part, when the direct drive is activated and without interconnection by a gear mechanism.

Finally, it is also possible to configure the actuator as a piezoelectric drive, as the actuating forces generated by a drive of this type can be sufficiently amplified by the self-reinforcing arrangement so as to ensure the desired deceleration of the rotational movement of the belt roll. All the preferred actuators are characterized by good controllability and in particular by high dynamism. This means that the actuating force generated by the relevant actuator can be particularly well adapted to the occupant-, vehicle- and/or situation-specific parameters in the event of a crash.

In a further embodiment of the belt retractor, the actuator is positioned radially outside the belt roll and essentially adjacent to the belt roll. In this context, the expression “essentially adjacent” means that the actuator can be positioned immediately adjacent to the belt roll. Alternatively however, other components, such as a housing part, can be arranged between the belt roll and the actuator in order to support the actuator.

Furthermore, it is possible to position the actuator radially outside the rotary member and essentially adjacent to the rotary member. For example, the actuator can be affixed to a section of the second carrier part that is essentially parallel to the shaft of the belt roll and which extends around the rotary member. The expression “essentially adjacent” again means that the actuator can be positioned immediately adjacent to the rotary member. However, other components, such as the previously mentioned section of the second carrier part, may be located between the rotary member and the actuator in order to support the actuator.

Finally, the actuator can be positioned on a side of the rotary member facing away from the belt roll and essentially adjacent to the rotary member. As explained previously, the term “essentially adjacent” expresses that the actuator can indeed be positioned immediately adjacent to the rotary member, but it is also conceivable that other components are arranged between the rotary member and the actuator. The variation in the position of the actuator means that the belt retractor according to an embodiment can be particularly well adapted to specific installation requirements in various motor vehicle models.

The first carrier part can preferably be mounted in such a way that it can be moved along its axis of rotation. Consequently, when the actuator is actuated, the first carrier part is moved axially in the direction of the rotary member by a force that is introduced to the first carrier part by means of the first and second force-amplification elements and that acts parallel to the axis of rotation of the first carrier part. A sliding bearing can be used to mount the first carrier part for example. Alternatively, the axial movement of the first carrier part can also be guided by the interaction between a thread provided on the first carrier part and a fixed spindle. The first carrier part can carry at least a first frictional element on a face that faces the rotary member and that extends essentially parallel to the rotary member. If the first carrier element is moved in an axial direction, this first frictional element is pushed against the rotary member and thus decelerates the rotational movement of the belt roll as soon as there is a torsion-proof connection between the belt roll and the rotary member. It shall be understood that several frictional elements, for example arranged rotationally symmetrically around the axis of rotation of the rotary member, can be affixed to the first carrier part.

In a further embodiment of the belt retractor, the rotary member is mounted in such a way that it can be moved along its axis of rotation. For example, a shaft of the belt roll, with which the rotary member can be connected in a torsion-proof manner, can be mounted in a floating manner. In an arrangement of this type, the rotary member is moved in an axial direction together with the first carrier part if the first frictional element affixed to the first carrier part is pushed against the rotary member by an actuation of the actuator.

At least one second frictional element can be affixed to a face of the second carrier part that faces the rotary member and that extends essentially parallel to the rotary member. In an arrangement of this type, the rotary member that is mounted so as to be axially moveable is also moved axially and pushed against the at least one second frictional element by the actuation of the actuator and the axial movement of the first carrier part associated therewith. It shall be understood that several second frictional elements can be provided, which are affixed to the second carrier part, for example rotationally symmetrically about the axis of rotation of the rotary member.

In order to set a distance between the first and second carrier parts, a further embodiment of the belt retractor comprises a return spring. The return spring has a first and a second end, whereby the ends of said return spring can preferably be supported on the first carrier part and the second carrier part respectively.

At least one spacer element can be provided to set a neutral position relative to the first and second carrier elements of the rotary member that is mounted so as to be axially moveable. For example, a first spacer element consists of a first spring and sets a distance between the first carrier part and the rotary member. A second spacer element, also configured as a spring, can be provided to set a distance between the rotary member and the second carrier part.

The return springs and the spacer elements prevent the rotary member from rubbing against the at least one frictional element when the actuator is not actuated. In other words, the return springs and the spacer elements enable a desired clearance to be set between the rotary member and the at least one frictional element. Actuation by the actuator compresses the at least one spacer element so that the first carrier part and, if appropriate, the rotary member can be pushed in an axial direction against the force of the return spring in order to bring the at least one frictional element into contact with the rotary member.

In a further embodiment of the belt retractor, the self-reinforcing arrangement comprises a spring element that is arranged in such a way that it exerts a force on the first carrier part acting in the circumferential direction of the first carrier part. A spring element of this type can, for example, be configured as a coil spring, the ends of which are fixed respectively to the first carrier part and a fixed component, such as the second carrier part. By means of a spring element of this type, a force that results from the normal force introduced when the actuator is actuated and from the frictional force occurring at the rotary member can be varied with regard to its direction and magnitude.

Fundamentally, the direction and the magnitude of the resulting force depend on the wedge angle of inclination α or the spindle inclination and the friction coefficient of the at least one frictional element. In order for the optimum effect of the self-reinforcing arrangement to be achieved, the resulting force should act at right angles to the angled wedge face determined by wedge angle of inclination α or to an angled spindle face determined by the spindle inclination. Because the direction and the magnitude of the resulting force can be influenced by the spring element, the spring element allows compensation for a deviation in the wedge angle of inclination α or the spindle inclination, as well as in the friction coefficient of the at least one frictional element from an optimum value with regard to the effect on the resulting force. This means that higher tolerances can be applied for the wedge angle of inclination α or the spindle inclination and the friction coefficient of the at least one frictional element when manufacturing the belt retractor according to various embodiments.

In addition or alternatively thereto, the at least one frictional element can be made from a magnetic material in order to influence the force that results from the normal force introduced when the actuator is actuated and from the frictional force occurring at the rotary member in terms of its magnitude and direction. Finally, it is further possible to magnetize the first carrier part and/or to provide a magnet configured as a pot-type magnet for example in order to effect a change in the magnitude or the direction of the resulting force. The magnet preferably may apply a magnetic force to the rotary member and/or the first carrier part in order to push the rotary member in the direction of the at least one frictional element. The generation of a magnetic force which causes the first carrier part and/or the rotary member to be moved in an axial direction can also generate an additional normal force at the rotary member. This additional normal force can provide an amplification of the deceleration effect in the event of a crash and also brings about a quick activation of the deceleration arrangement. Furthermore, a non-linear variation of the resulting force is possible with a magnetic arrangement in the same way as with a spring element which has a non-linear spring characteristic.

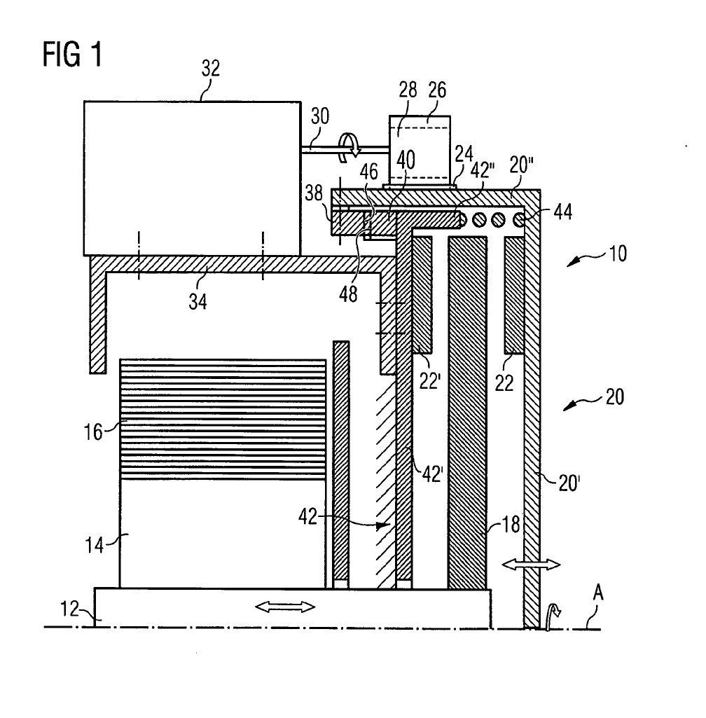

FIG. 1 shows a first embodiment of a belt retractor 10, whereby in FIG. 1 only a section of the belt retractor 10 that is located on one side of an axis of rotation A is represented in longitudinal cross-section. The belt retractor 10 comprises a belt roll 14 around which a belt strap 16 is wrapped and which is arranged in a torsion-proof manner on a shaft 12 that is mounted on a floating bearing. In order to wind and unwind the belt strap 16 onto and from the belt roll 14, the shaft 12 can be rotated with the belt roll 14 about the axis of rotation A. A brake disc 18 is arranged coaxially to belt roll 14 and is connected to shaft 12 in a torsion-proof manner and is thus rotatable together with the belt roll 14 about axis of rotation A.

A first carrier part 20 has a first section 20′, which extends essentially parallel to the brake disc 18 and carries a first frictional element 22 on its side facing the brake disc 18. A second section 20″ of the first carrier part 20 extends essentially at right angles to the first section 20′ around the outer circumference of the brake disc 18. The first carrier part 20 is mounted by means of a bearing not shown in FIG. 1 in such a way that it can be moved along axis of rotation A and rotated about axis of rotation A.

On its outer circumference, the second section 20″ of the first carrier part 20 is provided with external toothing 24 which interacts with external toothing 26 of a gear wheel 28. The gear wheel 28 is connected in a torsion-proof manner to a motor shaft 30 of an electric motor 32, whereby the electric motor 32 is positioned radially outside the belt roll 14 and is attached to a fixed housing part 34 which extends over the belt roll 14.

An electronic control unit not shown in FIG. 1 is provided to control the electric motor 32. The electronic control unit is in contact with sensors, also not shown, for detecting occupant-, vehicle- and/or situation-specific parameters, such as crash sensors, acceleration sensors, centrifuge sensors, sensors for detecting the occupant's weight and/or the occupant's position, etc.

A plurality of first wedges 38 is distributed around the inner circumference of the second section 20″ of the first carrier part 20 and attached to the second section 20″ of the first carrier part 20. A number of second wedges 40 corresponding to the number of first wedges 38 is attached to an outer face facing away from the brake disc 18 of a fixed second carrier part 42 which is connected to the housing part 34. The first and second wedges 38, 40 are arranged in such a way that their angled wedge faces 46, 48 are opposite each other and extend essentially at right angles to the axis of rotation A.

On its side facing the brake disc 18, a first section 42′ of the section carrier part 42, which extends essentially parallel to the brake disc 18, carries a second frictional element 22′. In order to set a distance between the first section 20′ of the first carrier part 20 and the first section 42′ of the second carrier part 42, a return spring 44 is provided, the ends of which rest respectively on the first section 20′ of the first carrier part 20 and a second section 42″ of the second carrier part 42 which extends essentially at right angles to the first section 42′.

Lastly, the belt retractor 10 intended for use in a motor vehicle has a belt pretensioner, also not shown in FIG. 1, which pulls the belt strap 16 tight to the body of a vehicle occupant to compensate for the belt slack if a driving assistance system and/or corresponding sensors detect a risk situation or an imminent crash. The electronic control unit used to control the electric motor 32 can also be used to control the belt pretensioner. Alternatively however, it is also possible to control the belt pretensioner by means of a separate electronic control unit. Actuating mechanisms that are considered for the belt pretensioner are mechanical systems with a pretensioned spring or pyrotechnical systems in which the belt is pulled tight by means of a pyrotechnical propellant charge. Alternatively, a high-dynamic electric motor can also be used to actuate the belt pretensioner, whereby either the electric motor 32 or an additional electric motor can be used.

The function of the belt retractor 10 is described below. In normal operation of the belt retractor 10, the belt strap 16 is wound onto belt roll 14 or unwound from belt roll 14 by the rotation of shaft 12 and the belt roll 14 which is connected to it in a torsion-proof manner about axis of rotation A. The brake disc 18, which is also arranged on shaft 12 in a torsion-proof manner, is also rotated about axis of rotation A by the rotation of shaft 12.

If the driving assistance system or a corresponding sensor, such as a crash sensor, detects a risk situation or an imminent crash, the electronic control unit actuates the belt pretensioner, whereupon the actuating mechanism of the belt pretensioner effects a rotation of the shaft 12 and thus of the belt roll 14 and the brake disc 18 about the axis of rotation A. The belt strap 16 is thus wound around belt roll 14 and the belt strap 16 is pulled tight against the body of the vehicle occupant.

In the crash itself, the rotational movement of shaft 12, the belt roll 14 and the brake disc 18 effected by the belt pretensioner is initially stopped as a result of the force acting on the belt strap 16. To prevent the shaft 12, the belt roll 14 and the brake disc 18 from rotating in the opposite direction and thus the belt strap 16 from unwinding from the belt roll 14, the electric motor 32 is actuated by the electronic control unit such that a rotation of the motor shaft 30 in a clockwise direction is transmitted to the first carrier part 20 by means of the gear wheel 28. The first carrier part 20 is thus turned in a clockwise direction about the axis of rotation A relative to the second carrier part 42. This causes the angled wedge faces 46 of the first wedges 38 attached to the second section 20″ of the first carrier part 20 to run against the angled wedge faces 48 of the second wedges 40 attached to the second carrier part 42, whereby the first carrier part 20 is pushed axially towards the brake disc 18 against the force of the return spring 44, i.e. to the left in FIG. 1, so that the first frictional element 22 comes into contact with the brake disc 18.

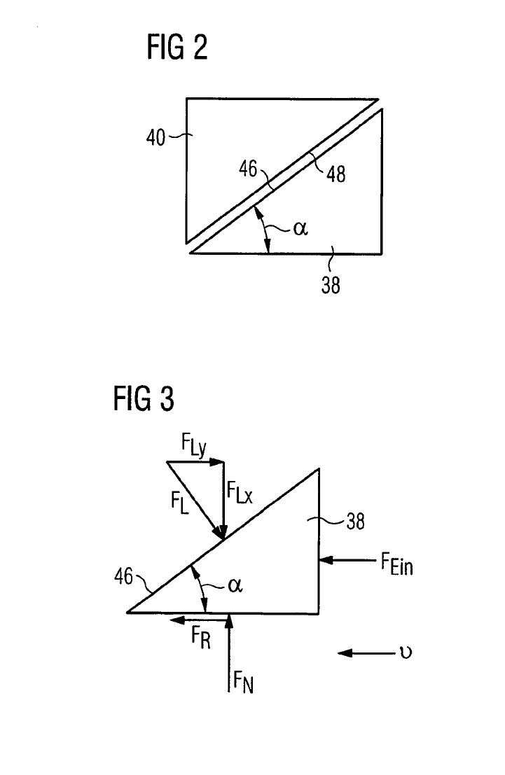

To better illustrate the effect of the first and second wedges 38, 40, a top view of a wedge arrangement with a first and second wedge 38, 40 is shown in FIG. 2. The first and the second wedges 38, 40 are arranged in such a way that the angled wedge face 46 of the first wedge 38 is opposite the angled wedge face 48 of the second wedge 40. An inclination P in wedge faces 46, 48 is determined by a wedge angle of inclination α in each instance. An axial movement s of the first carrier part 20 caused by the interaction of the first and second wedges 38, 40 is thus described by the formula

s=P·φ/(2·Π)

where φ is the angle of rotation of the first carrier part 20 about the axis of rotation A.

Although the wedge arrangement shown in FIG. 2 comprises a first and a second wedge 38, 40, the second wedge 40 can also be replaced by another suitable device, such as a pin, which enables the first wedge 38 to be supported in a sliding or rolling manner. Furthermore, a ball/ramp arrangement can also be used instead of the wedge arrangement shown in FIG. 2, as will be explained in more detail below.

If the first frictional element 22 comes into contact with the brake disc 18, the brake disc 18 is pushed, together with the first carrier part 20, towards the second carrier part 42, i.e. to the left in FIG. 1, due to the floating bearing of shaft 12, so that the brake disc 18 also comes into contact with the second frictional element 22′ with practically no delay.

In the belt retractor 10 shown in FIG. 1, the first carrier part 20, the second carrier part 42 and the first and second wedges 38, 40 form a self-reinforcing arrangement, that is, the actuating force introduced by the electric motor 32 by means of the gear wheel 28 is amplified automatically without any further forces being introduced from outside. In order to explain this self-reinforcing effect, FIG. 3 shows the equilibrium of forces on a first wedge 38 that result from an actuation of the electric motor 32, where F_{Ein} is the input force introduced into the first wedge 38 by the electric motor 32 and F_{L} is the reaction force that results when angled wedge face 46 of the first wedge 38 runs against the angled wedge face 48 of the second wedge 40 and which must be supported by the angled wedge face 48 of the second wedge, and which can be divided into a force F_{LY} that opposes the input force F_{Ein} and a compressive force F_{LX} which acts at right angles to the brake disc 18. F_{N} is the normal force opposing the force F_{LX} at the brake disc 18 and F_{R} the frictional force occurring at the first wedge 38 and at the frictional elements 22, 22′.

According to this equilibrium of forces, the frictional force F_{R}, which occurs when there is a relative movement between the brake disc 18 and the first or second frictional element 22, 22′ at a speed v, and the frictional torque on the side of the brake disc 18 on which the self-reinforcing arrangement is located are only a function of the wedge angle of inclination α, a friction coefficient μbetween the first and second frictional elements 22, 22′ and the brake disc 18, and the input force F_{Ein} according to the equation

F_{Ein}=−F_{R}·[(tan α/μ)]

The wedge angle of inclination α can essentially be selected such that the input force F_{Ein} introduced by the electric motor 32 is always positive in relation to the direction of rotation of the brake disc 18 (pressure wedge arrangement) regardless of the changing frictional coefficient μ that may be caused by external influences, such as the temperature. Alternatively however, the wedge angle of inclination at can also be selected such that the input force F_{Ein} introduced by means of the electric motor 32 is always negative in relation to the direction of rotation of the brake disc 18 (pulling wedge arrangement) regardless of the frictional coefficient μ. Finally, the wedge angle of inclination at can also be selected such that the first and the second wedges 38, 40 are located in an optimum operating state (usually that which occurs most often) close to a transition point between a pressure arrangement and a pulling arrangement.

The input force F_{Ein} introduced by the electric motor 32 is controlled by the electronic control unit in such a way that a desired frictional force F_{R} occurs at the brake disc 18 and a corresponding deceleration of the rotational movement of the shaft 12 and thus of the belt roll 14 is produced. The occupant-, vehicle- and/or situation-specific parameters recorded by the relevant sensors are used to determine a setpoint value for the frictional force F_{R}. The deceleration of the rotational movement of the belt roll 14 and thus the unwinding movement of the belt strap 16 from the belt roll 14 also occurs as a function of these parameters. In other words, an appropriate control of the input force F_{Ein} applied by the electric motor 32 as a function of the occupant-, vehicle- and/or situation-specific parameters enables the force acting on a vehicle occupant through the belt strap 16 to be individually adapted to these occupant-, vehicle- and/or situation-specific parameters. For this, the electronic control unit is equipped to control both the magnitude of the input force F_{Ein} and also a force progression, such as a time-dependent progression of the input force F_{Ein}, as required.

As emerges from the above equation, the frictional force F_{R} resulting from the input force F_{Ein} is a function of the friction coefficient μ, which may change to a relatively large degree as a function of the load acting on the first and second frictional elements 22, 22′ and of external influences, such as the temperature. In order to compensate for an undesired change of frictional force F_{R} caused by a change in friction coefficient, the belt retractor 10 as shown in FIG. 1 can comprise a sensor which enables a constant measurement of the frictional force F_{R}. The electronic control unit analyses the signals determined by this sensor and adapts accordingly the input force F_{Ein} introduced by the electric motor, based for example on a comparison between the setpoint value of the frictional force F_{R} and the actual value determined by the sensor, in order to bring the actual value of the frictional force F_{R} closer to the desired setpoint value.

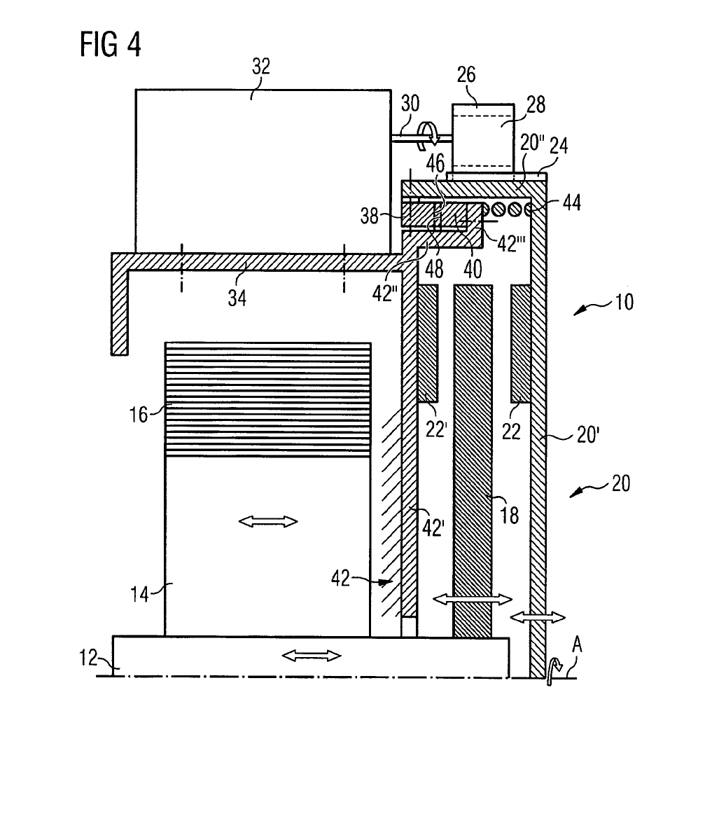

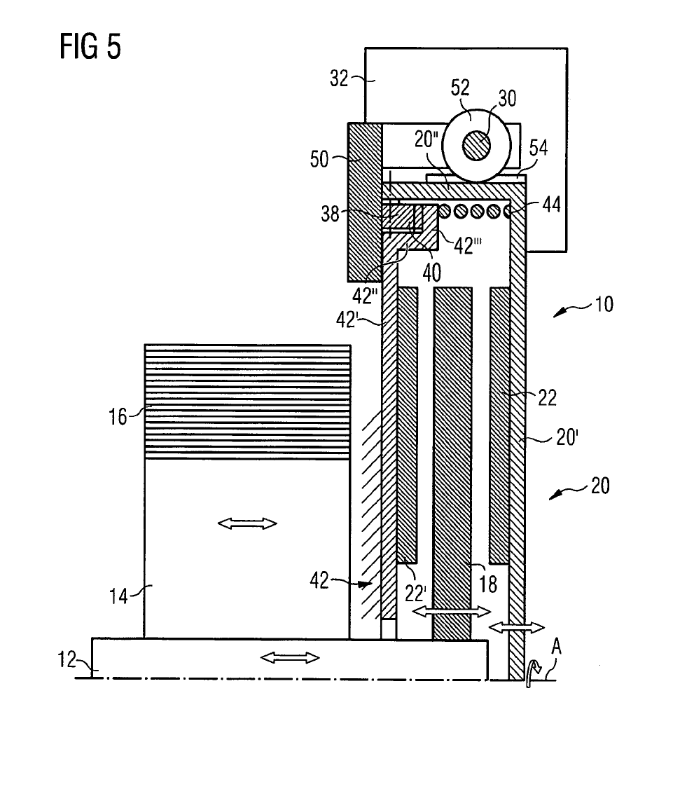

A second embodiment of a belt retractor 10, as shown in FIG. 4, differs from the arrangement shown in FIG. 1 in the structure of the second carrier part 42. According to FIG. 4, a second carrier part 42 comprises a first section 42′ that is essentially parallel to a brake disc 18 and a second section 42″ that is essentially at right angles to the first section 42′. Finally, a third section 42′″ is provided that is connected to the second section 42″ and, like the first section 42′, is again essentially parallel to the brake disc 18. The second and third sections 42″, 42′″ of the second carrier part 42 thus form an essentially L-shaped support for a first and second wedge 38, 40, so that the wedge arrangement is particularly well protected against environmental influences.

In the belt retractor 10 shown in FIG. 4, the ends of a return spring 44 for setting a distance between the first and the second carrier parts 20, 42 are supported respectively on a surface of the first section 20′ of the first carrier part 20 that faces a brake disc 18, and on an opposite surface of the third section 42′″ of the second carrier part 42.

In all other respects, the structure and the function of the belt retractor 10 shown in FIG. 4 correspond to the structure and the function of the arrangement shown in FIG. 1.

FIG. 5 shows a third embodiment of a belt retractor 10. The belt retractor 10 shown in FIG. 5 differs from the arrangement according to FIG. 4 firstly in that an electric motor 32 is no longer positioned radially outside a belt roll 14, but is rotated through 90° and is thus axially offset with the belt roll 14 and arranged radially outside a first carrier part 20. A housing part 34 shown in FIGS. 1 and 4 is not required in the belt retractor 10 shown in FIG. 5.

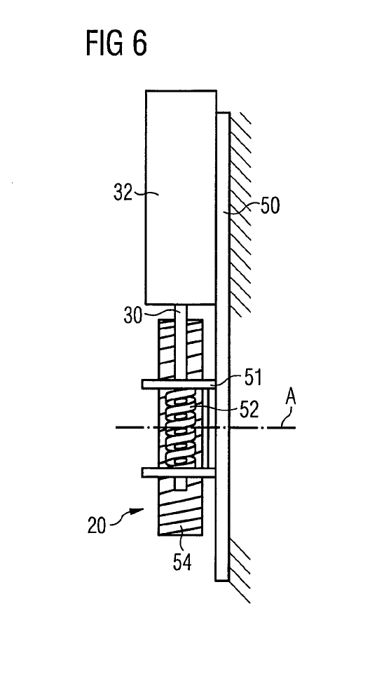

In order to transmit a rotational movement of a motor shaft 30 to the first carrier part 20, the motor shaft 30 is connected to a worm 52 mounted in a holder 51. As can be seen most clearly in FIG. 6, the worm 52 interacts with appropriate external toothing 54, which is configured around the outer circumference of a second section 20″ of the first carrier part 20. A worm gear of this type enables higher transmission ratios to be achieved compared to the gear wheel mechanisms shown in FIGS. 1 and 4.

In all other respects, the structure and function of the belt retractor 10 shown in FIG. 5 correspond to the structure and function of the arrangement shown in FIG. 4.

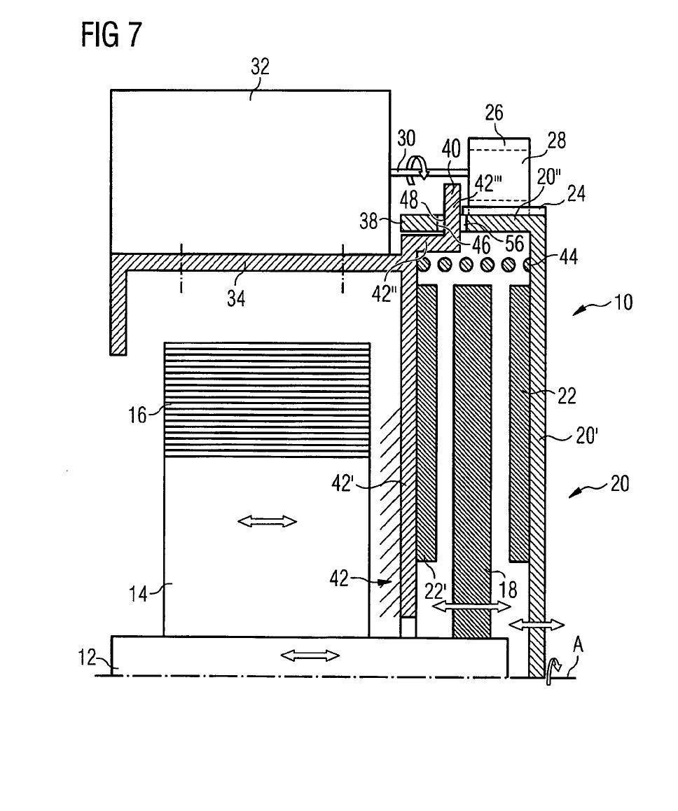

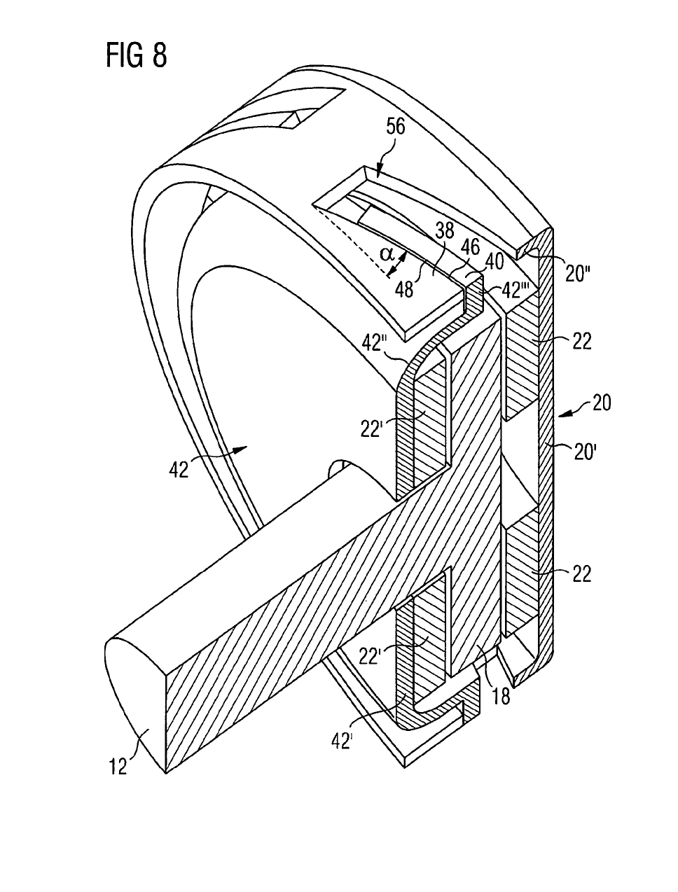

FIGS. 7 and 8 show a fourth embodiment of a belt retractor 10, which differs from the arrangement shown in FIG. 4 essentially in the configuration of the wedge arrangement. As can be seen most clearly in FIG. 8, a first carrier part 20 of the belt retractor 10 has a plurality of slots 56 in the second section 20″ of the first carrier part 20 distributed around the circumference of the second section 20″ of the first carrier part 20.

A second carrier part 42 comprises a first section 42′ that is essentially parallel to a brake disc 18, and a second section 42″ that runs essentially at right angles to the first section 42′. Several third sections 42′″ arranged around the circumference of the second section 42″ extend from the second section 42″ of the second carrier part 42 essentially at right angles to the second section 42″ and protrude through the slots 56 provided in the second section 20″ of the first carrier part 20.

The slots 56 are arranged in such a way that a side face which interacts with a corresponding third section 42′″ of the second carrier part 42 is angled at an angle α in relation to the brake disc 18 and thus forms an angled wedge face 46 in each instance. The third sections 42′″ of the second carrier part 42 are also angled at angle α in relation to the brake disc 18. A surface of each third section 42′″ of the second carrier part 42 which lies opposite an angled wedge face 46 formed by a slot 56 thus forms an angled wedge face 48 in each instance.

The ends of a return spring 44 for setting a distance between the first and the second carrier part 20, 42 are supported respectively on a side of the first section 20′ of the first carrier part 20 that faces the brake disc 18, and on a side of the first section 42′ of the fixed second carrier part 42 facing the brake disc 18.

If an electric motor 32 is actuated and the first carrier part 20 is thus turned in a clockwise direction relative to the fixed second carrier part 42, the angled wedge faces 46 formed by the slots 56 run against the angled wedge faces 48 of the corresponding third sections 42′″ of the second carrier part 42. This has the consequence, as described above, that the first carrier part 20 is moved axially towards the brake disc against the force of the return spring 44, i.e. to the left in FIG. 7, so that the first frictional element 22 comes into contact with the brake disc 18.

In all other respects, the structure and the function of the belt retractor 10 shown in FIGS. 7 and 8 correspond to the structure and function of the arrangement shown in FIG. 4.

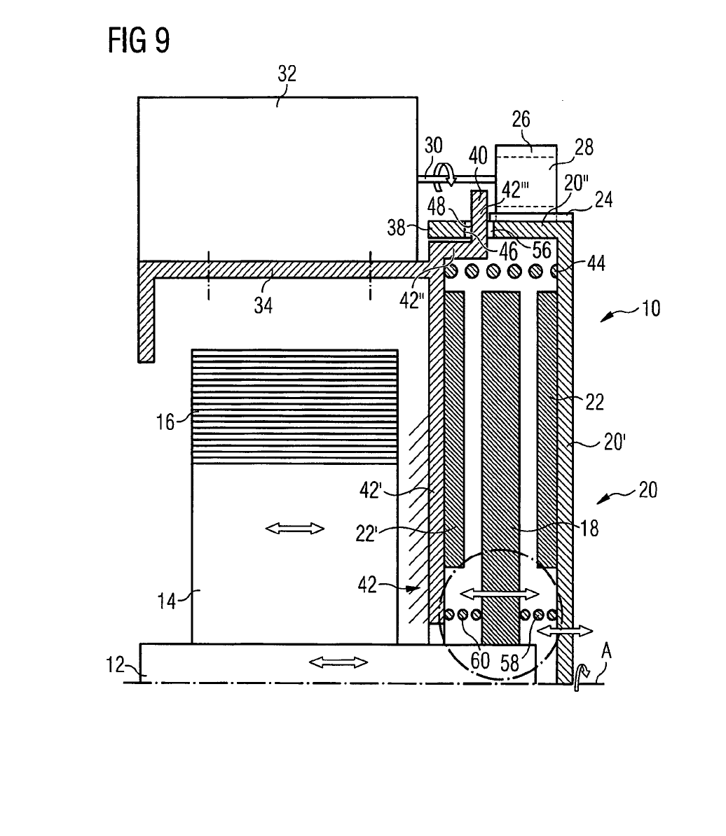

FIG. 9 shows a variant of the fourth embodiment of the belt retractor 10 according to FIGS. 7 and 8 which is additionally equipped with a first and second spacer element 58, 60, each in the form of a spring, in order to set a neutral position of a brake disc 18 relative to the first and second carrier parts 20, 42. The ends of the first spacer element 58 are supported respectively on a side of a first section 20′ of a first carrier part 20 which faces the brake disc 18, and on a facing side of the brake disc 18. The ends of the second spacer element 60 are supported respectively on a side of a first section 42′ of a second carrier part 42 which faces the brake disc 18, and on a facing side of the brake disc 18. If necessary, the belt retractor 10 can also comprise only one spacer element 58, 60.

By means of the first and second spacer elements 58, 60, the brake disc 18 can be positioned relative to the first and second carrier parts 20, 42 and thus to the first and second frictional elements 22, 22′ that are attached to the first and section carrier parts 20, 42 in a comparatively simple manner in terms of construction. The first and second spacer elements 58, 60, together with the return spring 44 if necessary, serve to set a desired clearance between the frictional elements 22, 22′ and the brake disc 18.

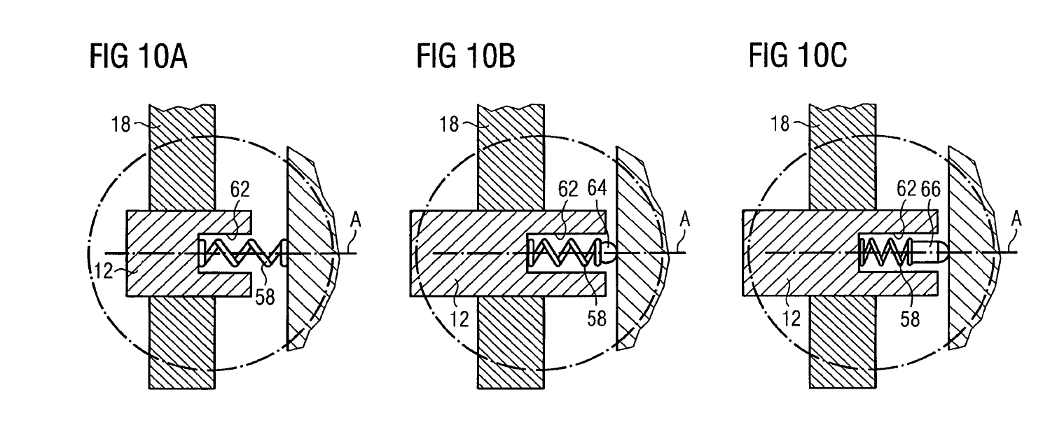

As is shown in FIG. 9, the first spacer element 58 can extend between the side of the first section 20′ of the first carrier part 20 that faces the brake disc 18 and a facing side of the brake disc 18. Alternatively however, a cylindrical hole 62 can be provided in a shaft 12 to accommodate the first spacer element 58, as shown in FIGS. 10a to 10c. The ends of the first spacer element 58 are then supported respectively on the side of the first section 20′ of the first carrier part 20 that faces the brake disc 18, and on a facing end face of the hole provided in the shaft 12.

In order to reduce the friction between the end of the first spacer element 58 and the first section 20′ of the first carrier part 20, the first spacer element 58 can be supported by means of a ball 64 on the side of the first section 20′ of the first carrier part 20 that faces the brake disc 18, as shown in FIG. 10b. As shown in FIG. 10c, the ball 64 can also be replaced by a more easily controllable pin 66.

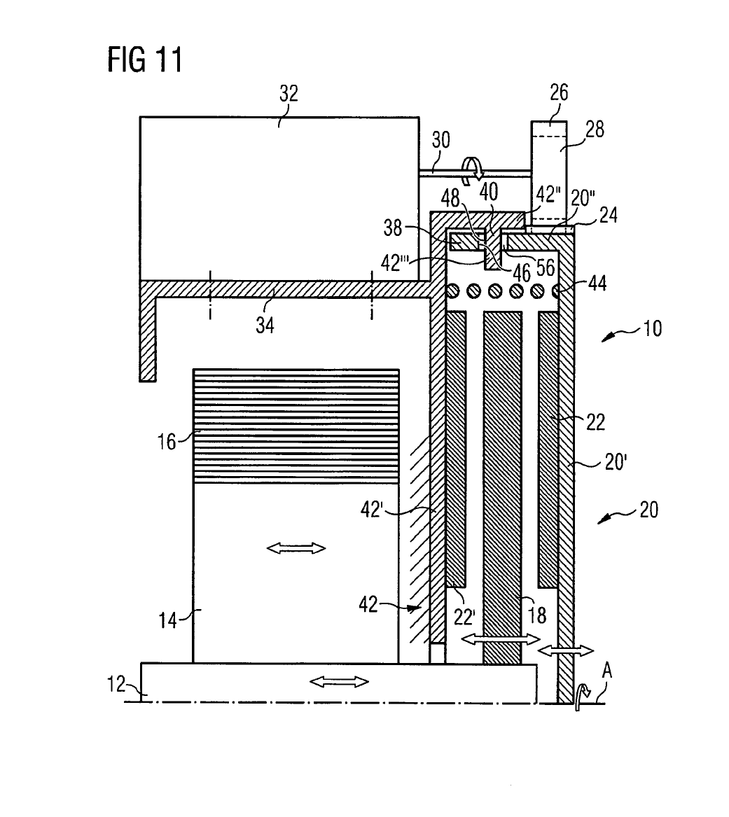

In a fifth embodiment of the belt retractor 10 shown in FIG. 11, a second carrier part 42 has several third sections 42′″ extending at right angles to a second section 42″ of the second carrier part 42, similar to the arrangements shown in FIGS. 7 to 9. However, the third sections 42′″ are not arranged around the outer circumference, but distributed around an inner circumference of the second section 42″ of the second carrier part 42 and attached to the second section 42″. In other words, the third sections 42′″ of the second carrier part 42 extend radially from the second section 42″ of the second carrier part 42 towards a shaft 12 and thereby protrude through appropriate slots 56 which are provided in a second section 20″ of the first carrier part 20.

As in the arrangements shown in FIGS. 7 to 9, the slots 56 are configured in such a way that a side face which interacts with a corresponding third section 42′″ of the second carrier part 42 is angled at an angle α relative to a brake disc 18 and thus forms an angled wedge face 46. The third sections 42′″ of the second carrier part 42 are also angled at the angle α in relation to the brake disc 18. A surface of a third section 42′″ of the second carrier part 42 which lies opposite an angled wedge face 46 formed by a corresponding slot 56 thus forms an angled wedge face 48.

The second section 42″ of the second carrier part 42 extends parallel to the second section 20″ of the first carrier part 20 to a length that is sufficient to cover the slots 56 provided in the second section 20″ of the first carrier part 20. The brake disc 18, frictional elements 22, 22′ and other components arranged between the first and second carrier parts 20, 42 are thus particularly well protected against environmental influences.

In all other respects, the structure and the function of the belt retractor 10 shown in FIG. 11 correspond to the structure and function of the arrangements shown in FIGS. 7 to 9.

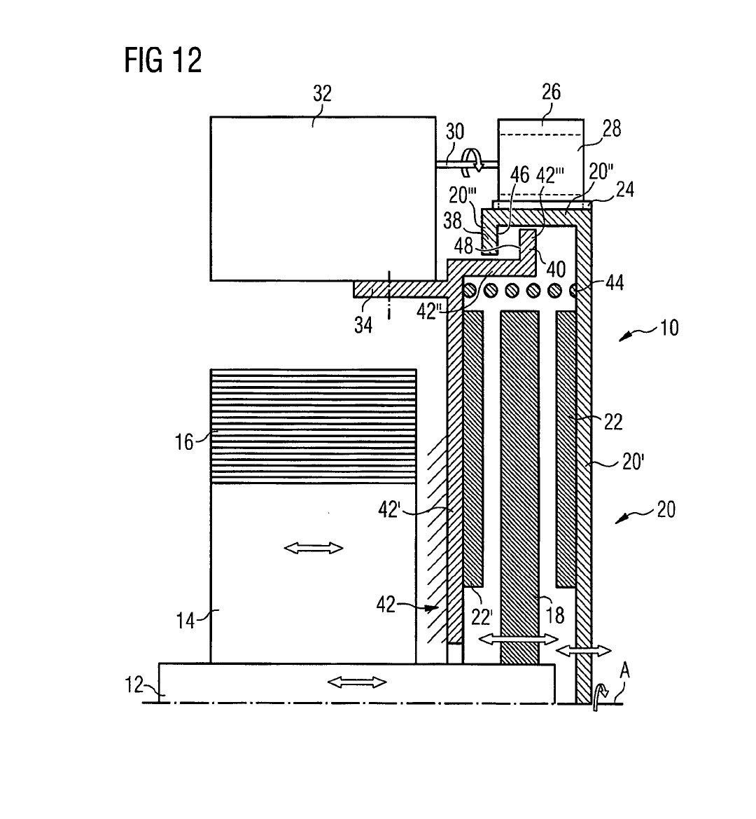

In a sixth embodiment of a belt retractor 10, as shown in FIG. 12, a housing part 34 no longer overlaps a belt roll 14, but only extends over a part of the outer circumference of the belt roll 14. However, the housing part 34 continues to serve as a mounting for the electric motor 32. It shall be understood that the embodiment of the belt retractor 10 shown in FIG. 12 can also be equipped with a differently configured housing part 34, for example as shown in FIG. 1 or 4.

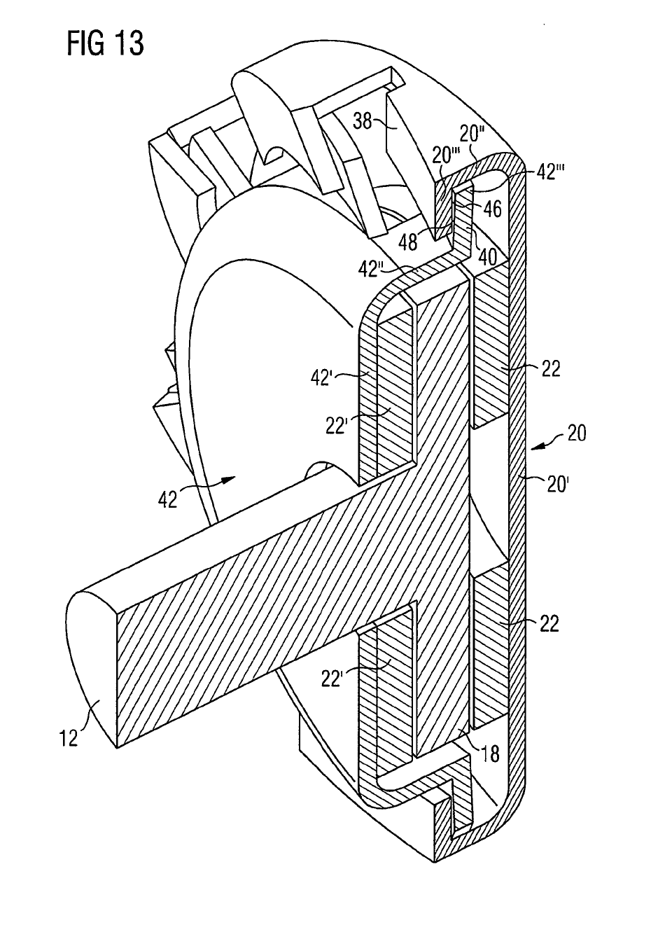

As can be most clearly seen in the spatial illustration in FIG. 13, a first carrier part 20 has a first section 20′ arranged essentially parallel to a brake disc 18, and a second section 20″ extending essentially at right angles to the first section 20′. From the second section 20″ of the first carrier part 20, several third sections 20′″ protrude radially towards a shaft 12 from an inner circumference of the second section 20″, whereby the third sections 20′″ of the first carrier part 20 are angled at an angle α relative to the brake disc 18. A surface of each third section 20′″ of the first carrier part 20 that faces the first section 20′ of the first carrier part 20 thus forms an angled wedge face 46 in each instance.

A second carrier part 42 comprises a first section 42′ that is arranged essentially parallel to the brake disc 18, and a second section 42″ that extends essentially at right angles to the first section 42′. From the second section 42″, several third sections 42′″ protrude radially outwards, whereby the third sections 42′″ of the second carrier part 42 are also angled at an angle α relative to the brake disc 18. Each third section 20′″ of the first carrier part 20 is thus assigned a corresponding third section 42′″ of the second carrier part 42, so that each angled wedge face 46 interacts with a facing angled wedge face 48 that is provided on each third section 42′″ of the second carrier part 42.

If the electric motor 32 is actuated, the first carrier part 20 is turned in a clockwise direction relative to the second carrier part 42, so that the angled wedge faces 46 on the third sections 20′″ of the first carrier part 20 run against the angled wedge faces 48 on the associated third sections 42′″ of the second carrier part 42. This has the consequence that the first carrier part 20 is moved axially towards the brake disc 18, so that a first frictional element 22 comes into contact with the brake disc 18.

In all other respects, the structure and function of the belt retractors 10 shown in FIGS. 12 and 13 correspond to the structure and function of the arrangement shown in FIGS. 7 to 9.

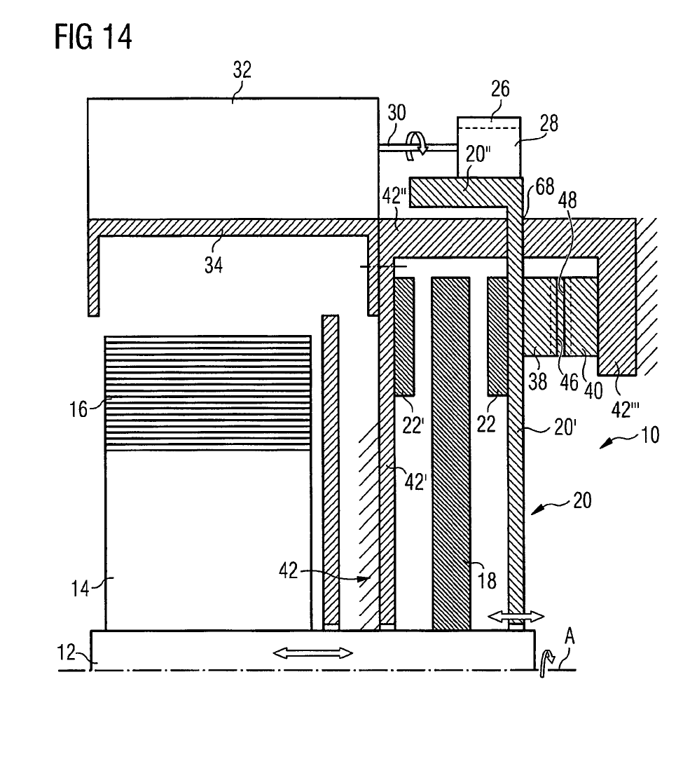

FIG. 14 shows a seventh embodiment of a belt retractor 10 which essentially differs from the arrangement shown in FIG. 1 in the position of a wedge arrangement. According to FIG. 14, a first carrier part 20 has a first section 20′ that is essentially parallel to a brake disc 18, and a second section 20″ that extends essentially at right angles to the first section 20′ around the circumference of the brake disc 18.

A second carrier part 42 comprises a first section 42′ that is essentially parallel to the brake disc 18, a second section 42″ that extends essentially at right angles from the first section 42′ around the circumference of the brake disc 18, and finally and third section 42′″ that protrudes radially from the second section 42″ towards a shaft 12 and is thus essentially parallel to the first section 42′ and the brake disc 18. In the second section 42′ of the second carrier part 42, there is a slot 68 extending along the circumference of the second carrier part 42, which is penetrated by the first section 20′ of the first carrier part 20.

A first wedge 38 is arranged on a side of the first section 20′ of the first carrier part 20 that faces away from the brake disc 18. A second wedge 40 which interacts with the first wedge 38 is attached to a surface of the third section 42′″ of the fixed second carrier part 42 that faces the first section 20′ of the first carrier part 20. The wedge arrangement of the first and second wedges 38, 40 is thus not positioned in the vicinity of a belt roll 14, as in the previously shown embodiments of the belt roll 10, but is positioned on a side of the brake disc 18 facing away from the belt roll 14.

In all other respects, the structure and the function of the belt retractor shown in FIG. 14 correspond to the structure and function of the arrangement shown in FIG. 1.

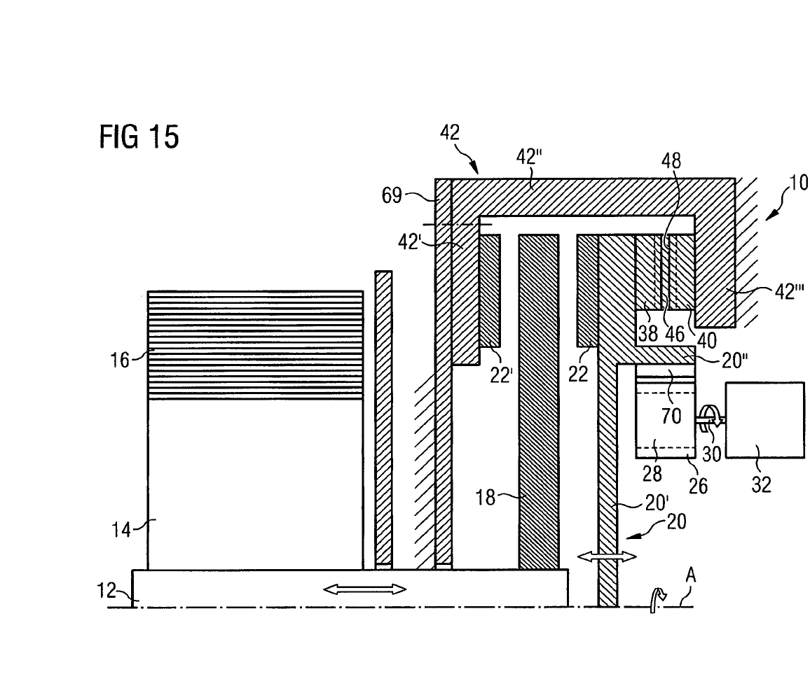

In a belt retractor 10 shown in FIG. 15, an electric motor 32 is not positioned radially outside a belt roll 14, as shown in the arrangement in FIG. 14, but is arranged on a side of the brake disc 18 that faces away from the belt roll 14. There is therefore no requirement for a housing part 34 for mounting the electric motor 32.

A first carrier part 20 has a first section 20′ that is essentially parallel to the brake disc 18, and a second section 20″ that extends essentially at right angles from the first section 20′ and that is radially inside a wedge arrangement comprising a first and second wedge 38, 40. As can be seen in FIG. 15, the second section 20″ of the first carrier part 20 is part of an L-shaped component that is fixed to the first section 20′ of the first carrier part 20. However, it shall be understood that the first carrier part 20 can also be configured as a single part.

A second carrier part 42 comprises a first section 42′ that is essentially parallel to the brake disc 18, a second section 42″ that extends essentially at right angles from the first section 42′ around the circumference of the brake disc 18, and finally a third section 42′″ that protrudes radially from the second section 42″ towards a shaft 12. The first section 42′ of the second carrier part 42 is rigidly connected to a fixed housing element 69.

Internal toothing 70 is configured on an inner circumference of the second section 20″ of the second carrier part 20, which interacts with the external toothing 26 of a gear wheel 28, which is connected to the electric motor 32 by means of a motor shaft 30.

In all other respects, the structure and the function of the belt retractor 10 shown in FIG. 15 corresponds to the structure and function of the arrangement shown in FIG. 14.

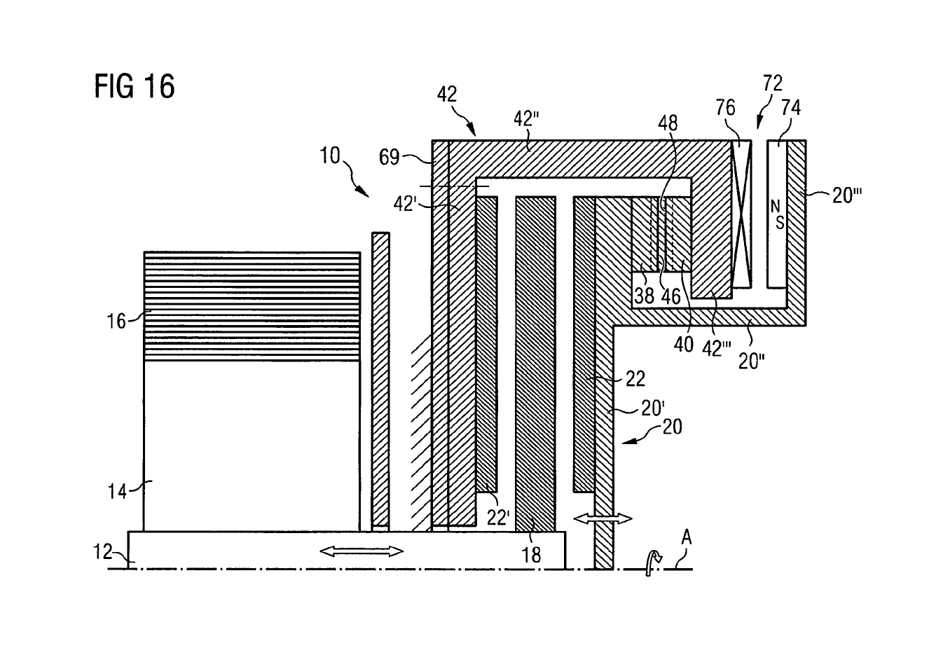

FIG. 16 shows a ninth embodiment of a belt retractor 10 which has a direct drive 72 instead of an electric motor 32. Similarly to the arrangement shown in FIG. 15, a first carrier part 20 comprises a first section 20′ that is essentially parallel to a first brake disc 18, and a second section 20″ that extends essentially at right angle to the first section 20′ and that is radially inside a wedge arrangement comprising a first and second wedge 38, 40. However, from the second section 20″ of the first carrier part 20, a third section 20′″ extends radially outwards essentially parallel to the brake disc 18. As can be seen in FIG. 16, the second and third sections 20″, 20′″ of the first carrier part 20 are parts of an essentially U-shaped component that is fixed to the first section 20′ of the first carrier part 20. However, it shall be understood that the first carrier part 20 can also be configured as a single part.

Similarly to the arrangement shown in FIG. 15, a second carrier part 42 comprises a first section 42′ that is essentially parallel to the brake disc 18 and attached rigidly to a fixed housing element 69, and a second section 42″ that extends essentially at right angles to the first section 42′ around the circumference of the brake disc 18. A third section 42′″ protrudes radially from the second section 42″ of the second carrier part 42 towards a shaft 12.

The third section 20′″ of the first carrier part 20 carries a plurality of rod-shaped magnets 74 on its side facing the brake disc 18, so that the first carrier part 20 forms a rotor of the direct drive 72. A ring-shaped stator coil 76 is fixed to a side of the third section 42′″ of the second carrier part 42 that faces away from the brake disc 18.

If the direct drive 72 is supplied with current, the first carrier part 20 is set in motion in a clockwise direction about axis of rotation A directly, i.e. without interconnection by means of a gear mechanism. An angled wedge face 46 of the first wedge 38 attached to the first carrier part 20 thus runs against an angled wedge face 48 of the second wedge 40 attached to the fixed second carrier part 42, such that the first carrier part 20 is moved axially towards the brake disc 18 and a first frictional element 22 is pushed against the brake disc 18.

The use of a direct drive 72 dispenses with the need to use a gear mechanism to transmit the drive force generated by the direct drive 72 to the first carrier part 20. Furthermore, the force of attraction between the rod-type magnets 74 and the stator coil 76 which pushes the first carrier part 20 axially towards the brake disc 18 generates an additional normal force at the brake disc 18.

In all other respects, the structure and the function of the belt retractor 10 according to FIG. 16 correspond to the structure and function of the arrangement shown in FIG. 15.

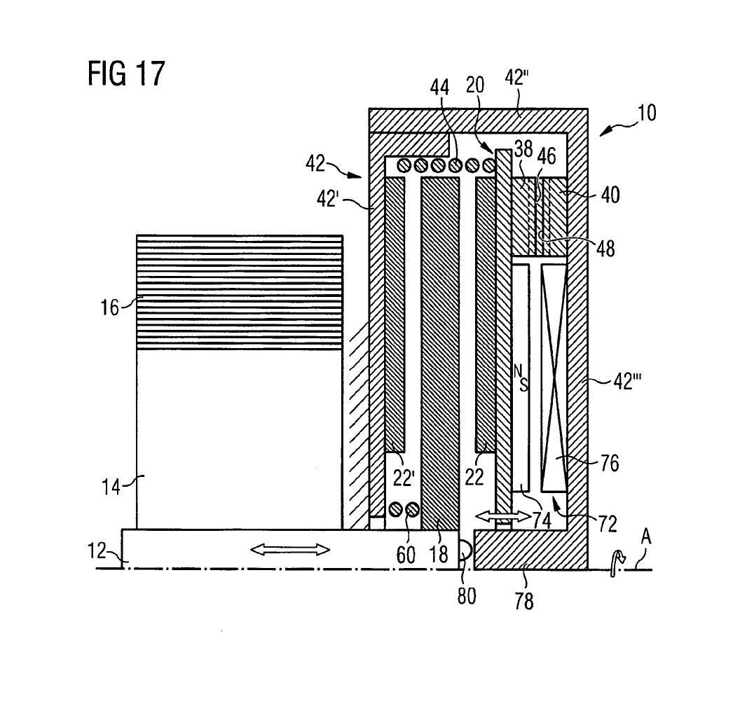

A tenth embodiment of a belt retractor 10 equipped with a direct drive 72 is shown in FIG. 17. In contrast to the arrangement illustrated in FIG. 16 however, a first carrier part 20 is configured as a disc and carries both a first wedge 38 and a plurality of rod-type magnets 74 of the direct drive 72 on its side facing away from a brake disc 18.

A fixed second carrier part 42 comprises a first section 42′ that is essentially parallel to the brake disc 18, and a second section 42″ that extends essentially at right angles to the first section 42′ around the outer circumference of the brake disc 18. From the second section 42″ of the second carrier part 42, a third section 42′″ extends again essentially parallel to the brake disc 18 and carries on its side facing the brake disc 18 a second wedge 40 which interacts with the first wedge 38, and a stator coil 76 of the direct drive 72. The third section 42′″ of the second carrier part 42 is rigidly connected to a bearing section 78, which forms an axial extension to a shaft 12, whereby the shaft 12 is supported on the bearing section 78 of the second carrier part 42 by means of a bearing 80 in such a way that it can be rotated. As can be seen in FIG. 17, the first section 42′ of the second carrier part 42 is formed by a fixed component that is rigidly connected to a component forming the second and third sections 42″, 42′″ and the bearing section 78 of the second carrier part 42. It shall be understood, however, that the second carrier part 42 can also be configured as a single part.

In order to set a neutral position of the first carrier part 20 relative to the first section 42′ of the second carrier part 42, a return spring 44 is provided, the ends of which are supported respectively on a side of the first carrier part 20 that faces the brake disc 18, and on a side of the first section 42′ of the first carrier part 42 that faces the brake disc 18. The return spring 44, the bearing 80 and a spacer element 60 that is configured as a spring between the first section 42′ of the second carrier part 42 and the brake disc 18 thus jointly enable a desired clearance to be set between the frictional elements 22, 22′ on the first and second carrier parts 20, 42 and the brake disc 18.

As can be seen in FIG. 17, an arrangement of the direct drive 72 that is radially inside the first and second wedges 38, 40 enables a particularly compact arrangement in which not only the direct drive 72, but also the wedges 38, 40, the first carrier part 20, the frictional elements 22, 22′ and the brake disc 18 are well protected from environmental influences.

If the direct drive 72 is supplied with current, the first carrier part 20, as in the arrangement shown in FIG. 16, is set in a rotational motion about the axis of rotation A relative to the second carrier part 42. This causes an angled wedge face 46 of the first wedge 38 attached to the first carrier part 20 to run against an angled wedge face 48 of the second wedge 40 attached to the third section 42′″ of the second carrier part 42, in such a way that the first carrier part is moved axially towards the brake disc 18 and the first frictional element 22 is pushed against the brake disc 18.

In all other respects, the structure and the function of the belt retractor 10 shown in FIG. 17 correspond to the structure and the function of the arrangement shown in FIG. 16.

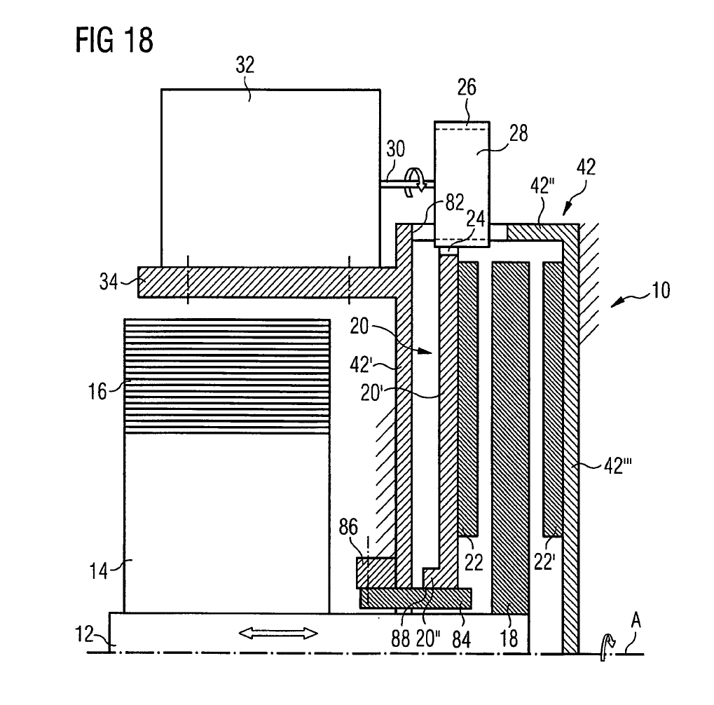

FIG. 18 shows an eleventh embodiment of a belt retractor 10, which differs from the arrangement shown in FIG. 1 in particular in the design of the self-reinforcing arrangement. In the same way as in the arrangement shown in FIG. 1, the belt retractor 10 according to FIG. 18 has an electric motor 32 that is arranged radially outside a belt roll 14 and attached to a housing part 34. The housing part 34 extends from a side of the first section 42′ of a fixed second carrier part 42 that faces away from a brake disc 18 around the outer circumference of the belt roll 14. Furthermore, the second carrier part 42 exhibits a second section 42″ that extends essentially at right angles from the first section 42′, and a disc-shaped third section 42′″ that is again essentially parallel to the brake disc 18.

A gear wheel 28 that is connected to the electric motor 32 by means of a motor shaft 30 protrudes through an opening 82 provided in the second section 42″ of the second carrier part 42 and interacts with external toothing 24 which is provided on an outer circumference of a first section 20′ of a first carrier part 20 that extends essentially parallel to the brake disc 18. Furthermore, the first carrier part 20 positioned between the first section 42′ of the section carrier part 42 and the brake disc 18 exhibits a second section 20″ that is essentially configured as a hollow cylinder and connected to the first section 20′. On its side facing the brake disc 18, the first section 20′ of the first carrier part 20 carries a first frictional element 22. A second frictional element 22′ is attached to a side of the third section 42′″ of the second carrier part 42 that faces the brake disc 18.

A spindle 84 that is configured as a hollow cylinder and penetrated by a shaft 12 is fixed rigidly to the first section 42′ of the second carrier part 42 by means of a fixing section 86 that is also configured as a hollow cylinder. The spindle 84 interacts with a thread 88 that is provided on an inner circumference of the second section 20″ of the first carrier part 20 that is configured as a hollow cylinder.

If the electric motor 32 is actuated, the first carrier part 20 is turned in a clockwise direction relative to the fixed second carrier part 42. This causes the thread 88 provided on the second section 20″ of the first carrier part to interact with the spindle 84 in such a way that the first carrier part 20 is moved axially towards the brake disc, i.e. to the right in FIG. 18. As a consequence, the first frictional element 22 is pushed against the brake disc 18. When the first frictional element 22 comes into contact with the brake disc 18, the brake disc 18 is pushed, together with the first carrier part 20, towards the second frictional element 22′, i.e. to the right in FIG. 18, due to the floating bearing of the shaft 12, so that the brake disc 18 comes into contact with the second frictional element 22′ with practically no delay.

The interaction of the thread 88 provided on the second section 20″ of the first carrier part 20 and the spindle 84 achieves a self-reinforcing effect in a similar way to the wedge arrangement described above. In other words, the input force introduced by the electric motor 32 by means of the gear wheel 28 is amplified automatically and without any other forces being introduced from outside, whereby FIG. 3 can be referred to regarding the equilibrium of forces that occurs with the interaction of the thread 88 with the spindle 84.

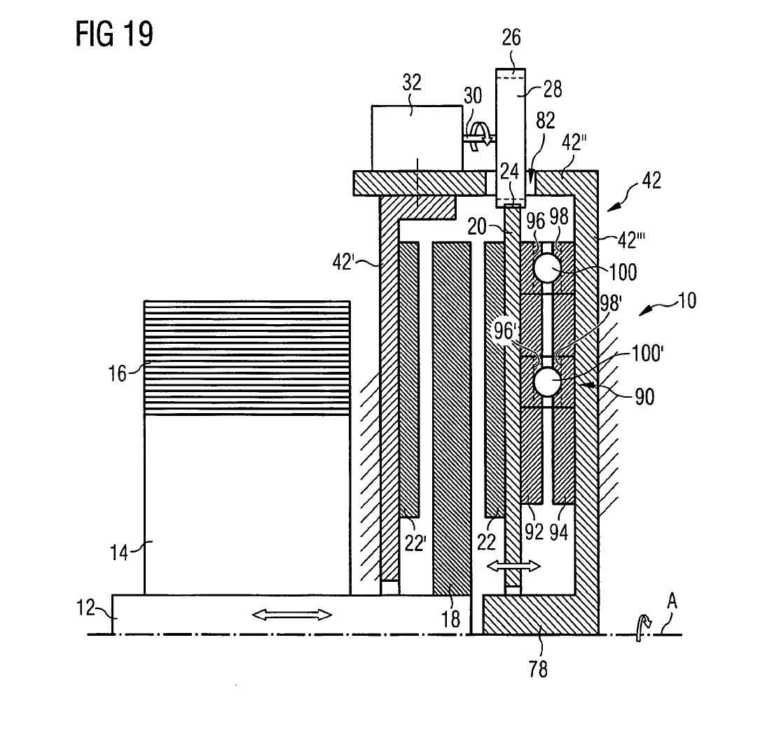

A further variant of a self-reinforcing arrangement is shown in FIG. 19. In a twelfth embodiment of a belt retractor 10 according to FIG. 19, a second carrier part 42 comprises a first section 42′ that is essentially parallel to a brake disc 18, a second section 42″ that extends essentially at right angles to the first section 42′, which is parallel to a shaft 12, and a third section 42′″ that is again essentially parallel to the brake disc 18. The third section 42′″ of the second carrier part 42 is connected rigidly to a bearing section 78 that forms an axial extension to a shaft 12. As can be seen in FIG. 19, the first section 42′ of the second carrier part 42 is formed by a fixed component that is rigidly connected to a component forming the second and third sections 42″, 42′″ and the bearing section 78 of the second carrier part. It shall be understood, however, that the second carrier part 42 can also be configured as a single part.

An electric motor 32 that is connected to a gear wheel 28 by means of a motor shaft 30 is fixed to an outer circumference of the second section 42″ of the second carrier part 42. The gear wheel 28 protrudes through an opening 82 provided in the second section 42″ of the second carrier part 42 and interacts with external toothing 26 that is provided on an outer circumference of a first carrier part 20. The disc-shaped first carrier part 20 is arranged essentially parallel to the brake disc 18 and carries a first frictional element 22 on its side that faces the brake disc 18. A second frictional element 22′ is attached to a side of the first section 42′ of the second carrier part 42 that faces the brake disc 18.

On a side of the first carrier part 20 that faces away from the brake disc 18, a ball/ramp arrangement 90 is provided between the first carrier part 20 and the third section 42′″ of the second carrier part 42. The ball/ramp arrangement 90 exhibits a first and a second bearing element 92, 94 on each of which are provided wedge faces 96, 96′, 98, 98′ angled in relation to the brake disc 18. The wedge faces 96, 96′, 98, 98′ form inner and outer ball tracks in which balls 100, 100′ are guided to support the wedge faces 96, 96′, 98, 98′ in a rolling manner.

If the electric motor 32 is actuated, the first carrier part 32 is set in a rotational motion by means of the gear wheel 28 in a clockwise direction relative to the second carrier part 42. By means of the interaction between the angled wedge faces 96, 96′, 98, 98′ and the balls 100, 100′, the ball/ramp arrangement 90 provides an axial movement of the first carrier part 20 towards the brake disc 18, so that the first frictional element 22 is pushed against the brake disc 18. Due to the floating bearing of the shaft 12, the brake disc 18 is then pushed, together with the first carrier part 20, towards the second frictional element 22′, i.e. to the left in FIG. 18, so that the brake disc 18 makes contact with the second frictional element 22′ with practically no delay.

As a result of the interaction between the angled wedge faces 96, 96′, 98, 98′ and the balls 100, 100′, the ball/ramp arrangement 90 has a self-reinforcing effect, i.e. the actuating force introduced by means of the electric motor 32 is automatically amplified, as in the wedge arrangement described above, whereby the representation in FIG. 3 can be referred to regarding the equilibrium of forces that occurs with the ball/ramp arrangement 90.

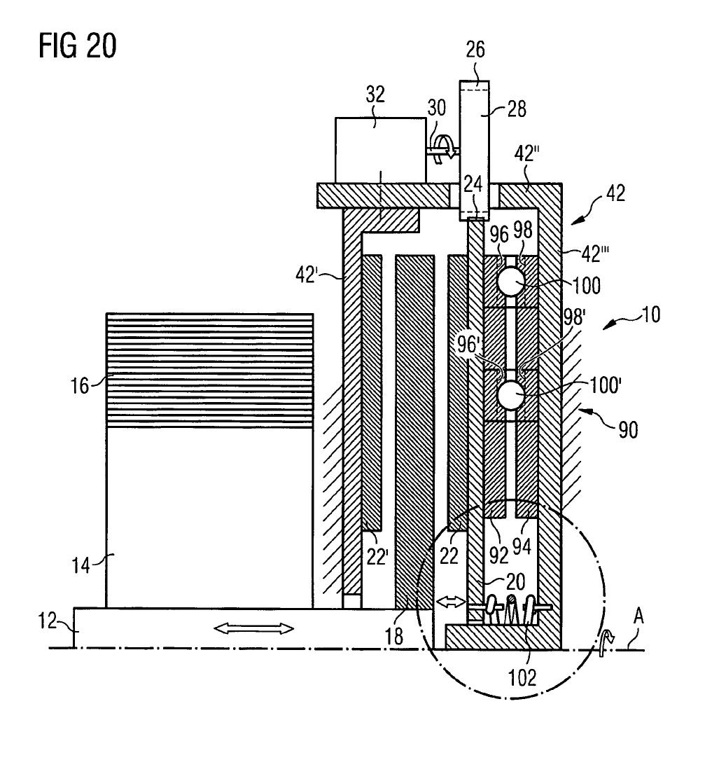

In contrast to the arrangement shown in FIG. 19, a thirteenth embodiment of a belt pretensioner 10 shown in FIG. 20 additionally exhibits a coil spring 102, the ends of which are fixed respectively to a third section 42′″ of a second carrier part 42 and a first carrier part 20. The coil spring 102 is thus able to apply a force to the first carrier part 20 that acts in the circumferential direction of the first carrier part 20.

The coil spring 102 enables a force that results from the normal force F_{N} introduced at a brake disc 18 when an electric motor 32 is actuated and the frictional force F_{R} occurring at the brake disc 18 to be varied in terms of its direction and its magnitude. Fundamentally, the direction and the magnitude of the resulting force depend on the angle of inclination of the angled wedge faces 96, 96′, 98, 98′ and a friction coefficient of the frictional elements 22, 22′ affixed to the first and second carrier parts 20, 42. In order for the optimum effect of the self-reinforcing arrangement to be achieved, the resulting force should act at right angles to angled wedge faces 96, 96′ provided on a first bearing element 92. Because the direction and the magnitude of the resulting force can be influenced by coil spring 102, the coil spring 102 allows compensation for a deviation in the angle of inclination and in the friction coefficient of the frictional elements 22, 22′ from an optimum value with regard to the effect on the resulting force.

As an alternative to the use of the coil spring 92, the frictional elements 22, 22′ can also be manufactured from a magnetic material in order to influence in terms of magnitude and direction the force that results from a normal force F_{N} introduced at the brake disc 18 when an electric motor 32 is actuated and the frictional force F_{R} occurring at the brake disc 18. Finally, it is also possible to manufacture the first carrier part 20 from a magnetic material in order to effect a change in the magnitude or the direction of the resulting force. The use of magnetic frictional elements 22, 22′ and/or a magnetic first carrier part 20 also enables a non-linear variation of the resulting force, in the same way as a spring 102 that has a non-linear spring characteristic. Furthermore, the magnetic force applied by the magnetic frictional elements 22, 22′ and/or the magnetic first carrier part 20 generates an additional normal force which, in the event of a crash, amplifies the deceleration effect and enables the brake arrangement to be activated quickly.

It shall be understood that the individual features shown and described above of the arrangements shown in FIGS. 1, 4 to 9 and 11 to 21 can be combined with each other as desired. For example, the electric motor 32 in the belt retractor 10 shown in FIG. 1 can be replaced by a direct drive. Furthermore, all belt retractor variations can, if desired, be equipped with a return spring 44 and with first and second spacer elements 58, 60 or with a coil spring 102.

In all the belt retractors 10 shown in the figures, a brake disc 10 is connected to a shaft 12 of a belt roll 14 in a torsion-proof manner. Contrary to this, it is also possible to uncouple a brake disc from a belt roll shaft during normal operation of the belt retractor and only connect it to the belt roll shaft in a torsion-proof manner in the event of a crash by means of a suitable mechanism, for example a ratchet mechanism. The brake disc can then rest against a frictional element in its neutral position without any clearance.

What is claimed is:

1. A belt retractor comprising a rotatable belt roll, a rotary member that can be connected to the belt roll in a torsion-proof manner, and an actuator that generates an actuating force and acts upon at least one frictional element in order to engage the frictional element with the rotary member that can be connected to the belt roll in a torsion-proof manner so as to decelerate a rotational movement of the belt roll, wherein an arrangement for self-reinforcing the actuating force generated by the actuator is disposed between the actuator and the rotary member.

2. The belt retractor according to claim 1, wherein the actuator is connected to an electronic control unit that is configured to control the actuator as a function of at least one occupant-, vehicle- and/or situation-specific parameter in order to effect a deceleration of the rotational movement of the belt roll that is adapted thereto.

3. The belt retractor according to claim 1, wherein
the self-reinforcing arrangement comprises a first carrier part that carries at least one first force-amplification element and a second carrier part that carries at least one second force-amplification element, wherein the first and the second carrier parts can be rotated relative to each other as a result of the actuating force generated by the actuator.

4. The belt retractor according to claim 3, wherein
the first force-amplification element comprises an angled wedge face with an angle of inclination that is supported on the second force-amplification element in a sliding or rolling manner.

5. The belt retractor according to claim 4, wherein
the first force-amplification element and the second force-amplification element form a ball/ramp arrangement.

6. The belt retractor according to claim 3, wherein
the first force-amplification element is configured as a thread provided on the first carrier part and the second force-amplification element is configured as a spindle that interacts with the thread provided on the first carrier part.

7. The belt retractor according to claim 3, wherein
the second carrier part is fixed and the first carrier part can be connected to the actuator in order to turn the first carrier part relative to the second carrier part.

8. The belt retractor according to claim 1, wherein
the actuator is configured as a rotating electric machine and can be connected to toothed or worm gearing.

9. The belt retractor according to claim 1, wherein
the actuator is configured as a direct drive or as a piezoelectric drive.

10. The belt retractor according to claim 1, wherein
the actuator is positioned radially outside the belt roll and essentially adjacent to the belt roll.

11. The belt retractor according to claim 1, wherein
the actuator is positioned radially outside the rotary member and essentially adjacent to the rotary member.

12. The belt retractor according to claim 1, wherein
the actuator is positioned on a side of the rotary member that faces away from the belt roll and essentially adjacent to the rotary member.

13. The belt retractor according to claim 3, wherein
the first carrier part is mounted in such a way that it can be moved along its axis of rotation and carries at least a first frictional element on a surface that faces the rotary member.

14. The belt retractor a according to claim 1, wherein
the rotary member is mounted in such a way that it can be moved along its axis of rotation.

15. The belt retractor according to claim 3, wherein
at least one second frictional element is attached to a surface of the second carrier part that faces the rotary member.

16. The belt retractor according to claim 3, wherein
a return spring is provided to set a distance between the first and the second carrier part.

17. The belt retractor according to claim 3, wherein
at least one spacer element is provided to set a neutral position of the rotary member relative to the first and second carrier parts.

18. The belt retractor according to claim 6, wherein
the self-reinforcing arrangement comprises a spring element that is configured to apply a force that acts on the first carrier part in a circumferential direction of the first carrier part.

19. The belt retractor according to claim 1, wherein
the at least one friction lining is made from a magnetic material and/or a pot-type magnet is provided that applies a magnetic force to the rotary member and/or the first carrier part in order to force the rotary member towards the at least one friction lining.

20. A method of using a belt retractor according to claim 1 in an adaptive seat-belt system.
